(19) United States
(12) Patent Application Publication
(10) Pub. No.: US 2025/0136062 A1
(43) Pub. Date: May 1, 2025

(54) Vacuum for Commercial Car Wash Facilities

(71) Applicant: ABC Manufacturing, LLC dba ABC Wash Systems, Rochester Hills, MI (US)

(72) Inventor: Ismael Mosa-Basha, Rochester Hills, MI (US)

(21) Appl. No.: 18/933,324

(22) Filed: Oct. 31, 2024

Related U.S. Application Data
(60) Provisional application No. 63/594,488, filed on Oct. 31, 2023.

(51) Int. Cl. B60S 3/00; A47L 9/22; A47L 9/24

(52) U.S. Cl. CPC B60S 3/008; A47L 9/22; A47L 9/242

(57) ABSTRACT

A vacuum/separator for a commercial car wash facility comprising a vacuum assembly and a movable collector assembly, wherein the vacuum assembly comprises at least one vacuum source and further wherein the movable collector assembly comprises a bucket; one or more mounting/bearing brackets attached to the vacuum assembly and including a vertical channel and a horizontal channel; a handle/roller assembly movably attached to the one or more mounting/bearing brackets and including a vertical roller and a horizontal roller and a bucket rotational assembly.

### CLAIM OF PRIORITY

This application claims the benefit of the filing date of U.S. Provisional Application Ser. No. 63/594,488, filed on Oct. 31, 2023. The contents of that application are incorporated by reference herein in their entirety and for all purposes.

### FIELD

The present teachings relate generally to an improved vacuum/separator device for use in a commercial car wash facility. More specifically, the present teachings are directed to a vacuum/separator device that has an improved design that allows for easy collection and removal of heavier debris that is collected by the vacuum during use.

### BACKGROUND

It is a well-known problem that people can misplace valuable items in hard to access spaces in their vehicles. This can present challenges when the vehicle is vacuumed, as these items may be inadvertently sucked up by the vacuum. It is also well-known and commercial car wash vacuum systems contain significant amounts of dirt and debris. Thus, if a commercial vacuum collects a valuable item, it is time consuming and extremely messy to open up the commercial vacuum and sift through the dirt and debris in hopes of discovering the valuable item. The present invention seeks to provide an innovative solution to one or more of the problems discussed above by providing a superior vacuum/separator that allows for heavy and/or large debris that could be valuable to be automatically separated from the remaining dirt and debris collected by the vacuum.

### SUMMARY

The teachings herein are directed to a vacuum/separator for a commercial car wash facility comprising a vacuum assembly including at least one vacuum source and a movable collector assembly comprising a bucket, one or more mounting/bearing brackets attached to the vacuum assembly and including a vertical channel and a horizontal channel, and a handle/roller assembly movably attached to the one or more mounting/bearing brackets and including a vertical roller and a horizontal roller.

The vertical roller and the horizontal roller may each be disposed in and move within the vertical channel and the horizontal channel respectfully to and from a closed position and an open position.

The bucket may include a bucket rotational assembly. The bucket rotational assembly may include a flange bearing. The bucket rotational assembly and the horizontal roller may rotate about a pin. the horizontal and vertical rollers may be located at a first axis in the closed position and a second, different axis in the open position. The vacuum assembly may include an upper compartment and a lower compartment.

Dust and small particulate dirt and debris may be collected into the upper compartment. Large and/or heavy debris may move through the lower compartment and into the bucket.

The vacuum source may originate from a suction device in the upper compartment. A hose fitting may be located on the lower compartment. The top compartment may include one or more mounting brackets for connecting the vacuum/separator to a car wash assembly. The vertical roller may include a flange bearing for receiving an attachment bolt.

### BRIEF DESCRIPTION OF THE DRAWINGS

FIG. 1 is a perspective view of a car wash with an exemplary vacuum/separator and a close-up view thereof according to the present teachings.

FIG. 2 is a perspective view (exploded) of an exemplary vacuum/separator according to the present teachings.

FIG. 3 is a side view of an exemplary vacuum/separator according to the present teachings.

FIG. 4 are two perspective views of an exemplary vacuum/separator according to the present teachings including a close up of the locking mechanism.

FIG. 5 a side view of an exemplary vacuum/separator according to the present teachings in the closed position.

FIG. 6 is a side view of an exemplary vacuum/separator according to the present teachings in an intermediate position.

FIG. 7 is a side view of an exemplary vacuum/separator according to the present teachings in an open position and the bucket rotated.

FIG. 8 is an exemplary side view of an exemplary movable collector assembly in accordance with the teachings herein.

FIG. 9 is a sectional view of the assembly of FIG. 8

FIG. 10 is a center cut sectional close-up view of exemplary rollers in accordance with the teachings herein.

### DETAILED DESCRIPTION

The present teachings meet one or more of the above needs by the improved devices and methods described herein. The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

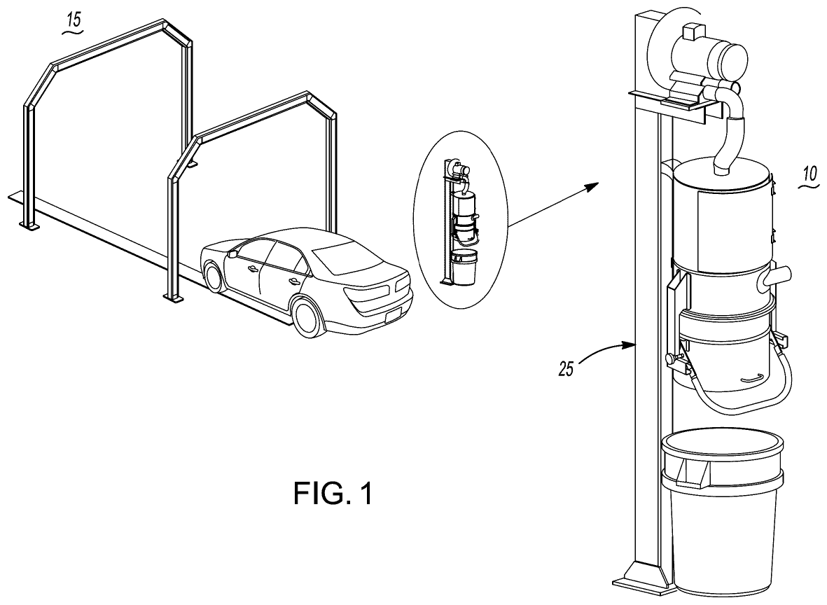

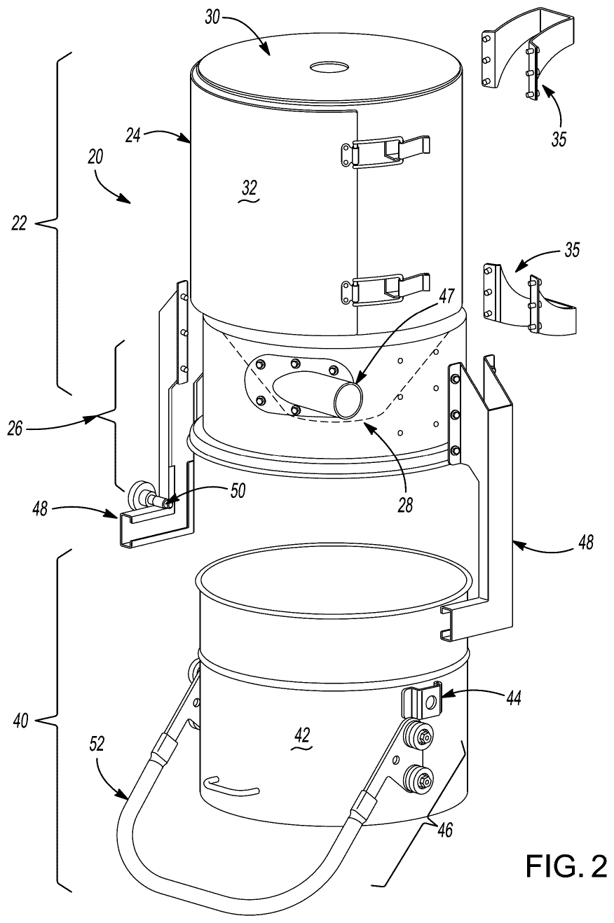

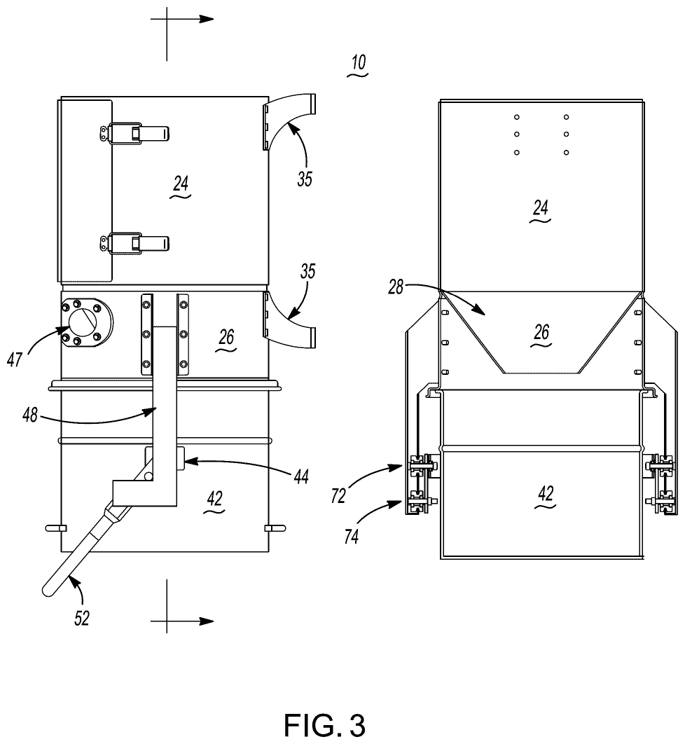

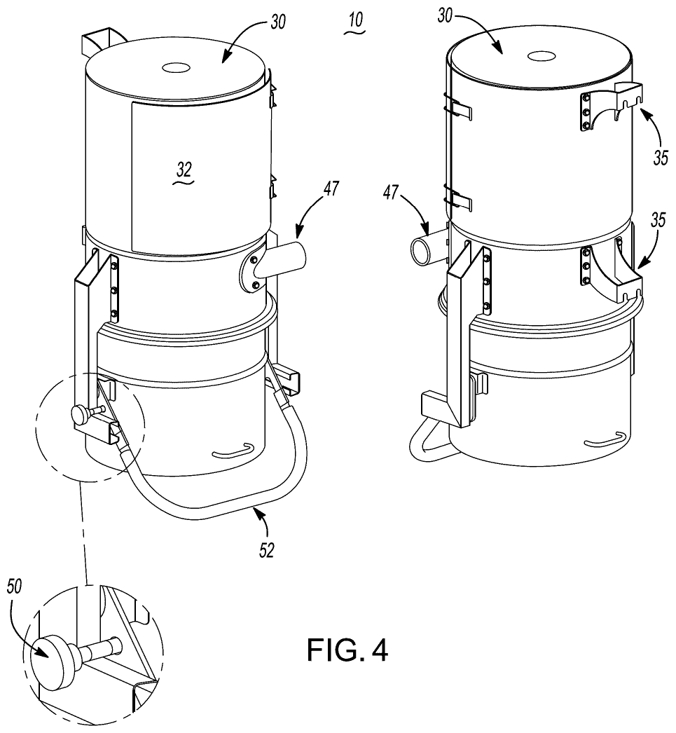

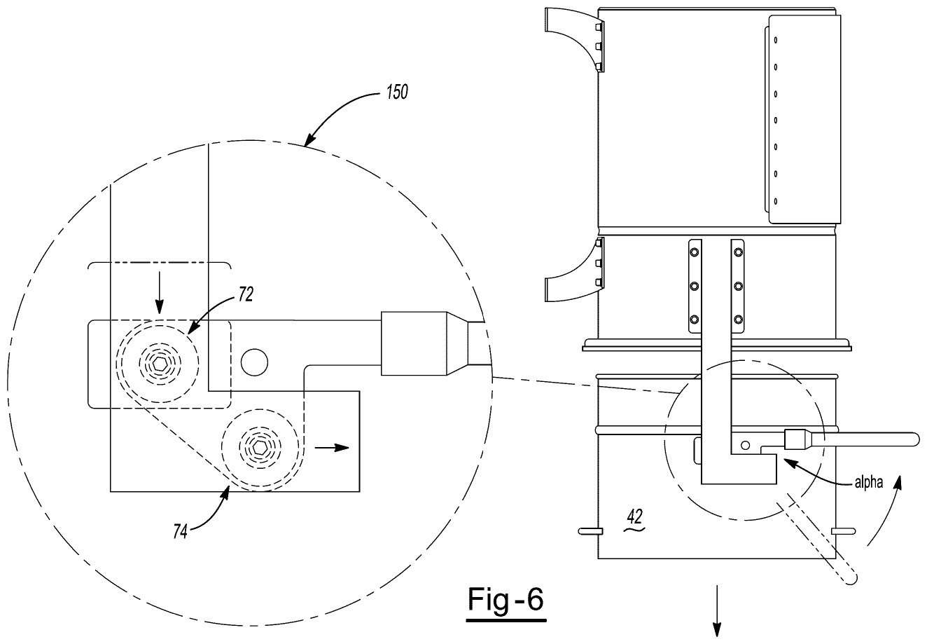

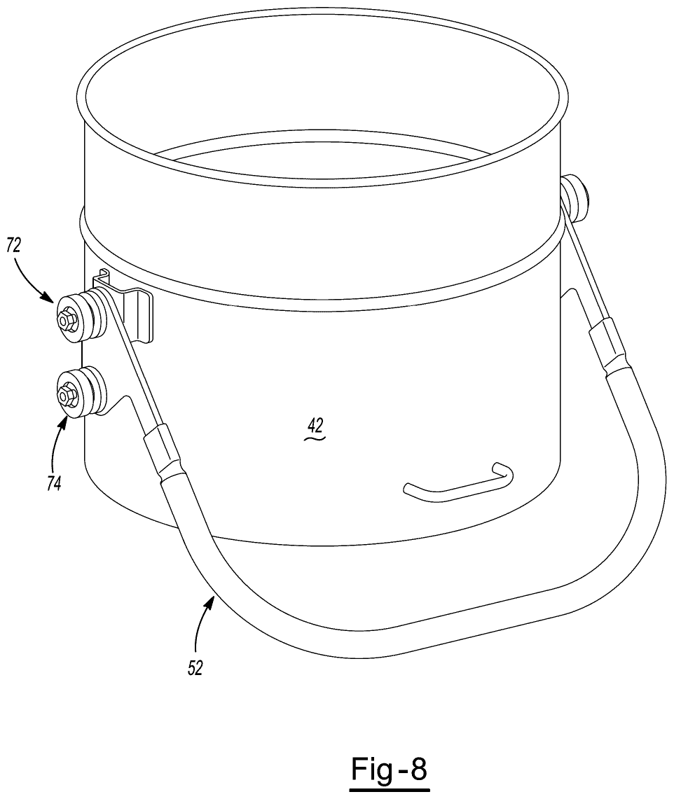

FIGS. 1 through 10 illustrate an exemplary vacuum/separator 10 and its various components. It is contemplated that the vacuum/separator 10 is utilized in a commercial car wash facility 15 where the vacuum/separator 10 is designed to allow for efficient collection and removal of debris while also allowing for easy access to potentially valuable items collected by the vacuum. Each of the major components of the vacuum/separator 10 are discussed in further detail below.

Typically, in commercial car wash facilities, the car wash 15 provides a tunnel in which soap, water, wax, polish, and the like are applied to a car in various steps. It also typically has one or more heavy duty vacuums that can be used by staff or customers to clean the insides of the vehicle. It is also well known that all kinds of debris may be collected in the vacuum while vacuuming and it may be important to collect this debris so unintended items (e.g., coins/bills/jewelry/keys) that have been collected can be easily retrieved.

It is contemplated that the vacuum/separator 10 consists of a plurality of components, which may include a vacuum assembly 20 and a movable collector assembly 40 as well as other components such as a mounting post 25 (generally associated with the car wash 15), mounting brackets 35 and one or more hoses. These components and assemblies will be further detailed in the drawing figures and in the paragraphs of this application.

It is contemplated that the vacuum/separator 10 may have several embodiments of vacuum assembly 20 in which the mechanism that creates the suction force may be internal to or external to said assembly 20. It is contemplated that the configuration of the collector assembly 40 is independent of the style/embodiment of the vacuum assembly 20.

It is further contemplated that the vacuum assembly 20 functions to provide the means of producing suction (e.g., a vacuum source) to a hose via a hose fitting 47. It may include a vacuum main body 22 with at least two compartments 24 and 26, an inside cone 28, a top cover 30, and an access door 32. The upper compartment 24 is where the suction means originates (either from a pump/motor mechanism disposed therein or via a pump/motor mechanism external to the vacuum/separator 10 and in fluid communication therewith). The lower compartment 26 may be open at the bottom to the collector assembly 40 and to the upper compartment 24 via a hole in the inside cone 28. It is also contemplated that that the hose fitting 47 is disposed along a side wall of the lower compartment 26 (above the bottom of the inside cone 28) such that incoming debris can fall down into the collector assembly 40 while essentially dusty air (air containing dirt and debris particulates) is sucked into the upper compartment 24. It is contemplated that other configurations of the vacuum assembly 40 are possible, but still are part of the greater inventive vacuum/separator 10 so long a they function to allow heavier and/or larger debris to fall down into the collector assembly.

It is contemplated that the collector assembly 40 functions as the collection vessel for debris suctioned up by the vacuum/separator 10. It may include a number of components, preferably components that include a main bucket 42 and a mechanism/assembly for moving the bucket that allow easy inspection and emptying of the bucket 42. In a preferred embodiment, the mechanism/assembly may include one or more mounting/bearing brackets 44, a handle/roller assembly 46 and a bucket rotational assembly 48. It is also contemplated that there is a locking mechanism 50 that holds the bucket 42 in place and one or more bucket handles 52 that can help a user move/rotate the bucket 42.

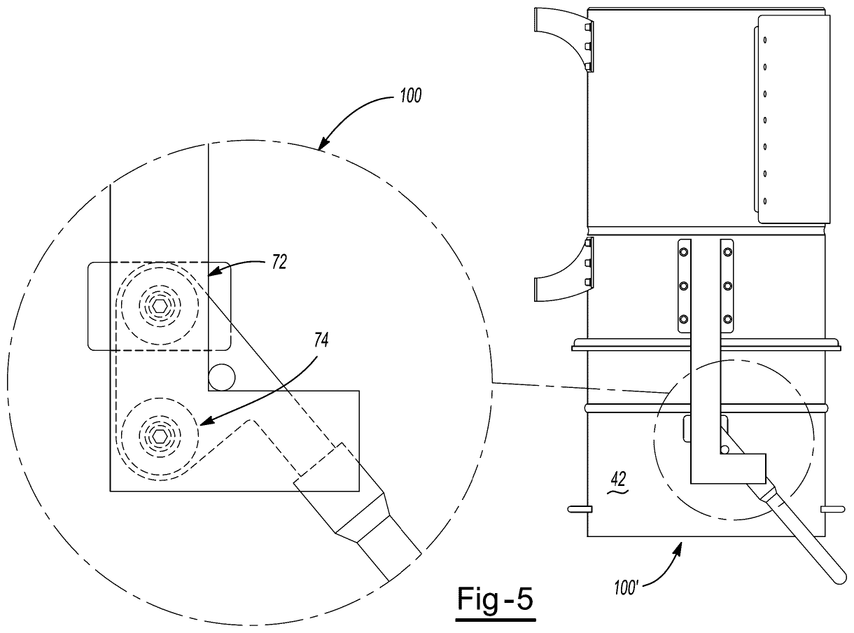

It is contemplated that the bucket 42 is a container that is attached to the vacuum assembly 20 via the one or more handle/roller assembly 46. The bucket rotational assembly 48 may move from a closed position 100 to an open position 200 (via an intermediate position 150) via movement of the handle/roller assembly 46 within the brackets 44 as shown in FIGS. 5 through 7.

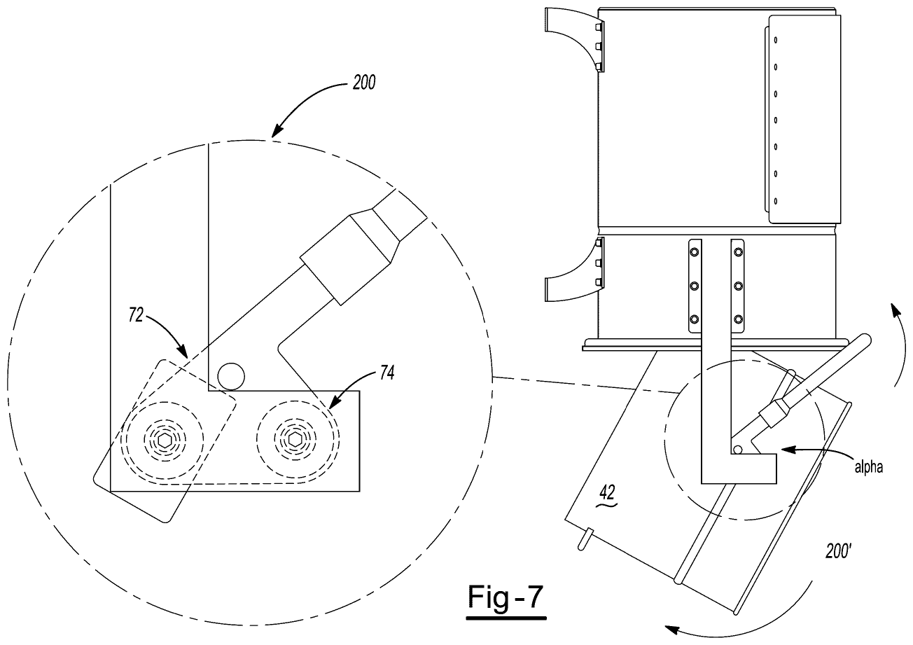

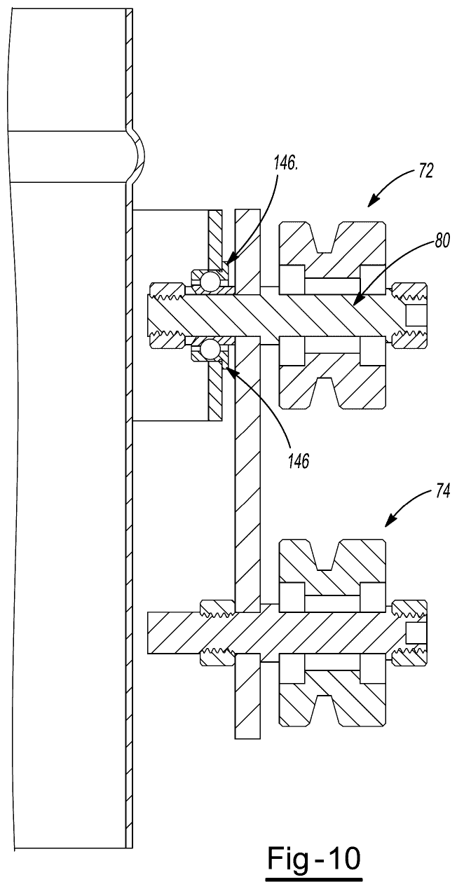

It is further contemplated that the brackets 44 may comprise two or more channels (vertical and horizontal 62/64) that are adapted to house two or more rollers/wheels (vertical and horizontal 72/74) from the handle/roller assembly 46. It is contemplated that the rollers 72/74 travel along and within their respective channel and move the bucket 42 to and from open/closed positions 200/100. It is also contemplated that when in the open position 200, the bucket can rotate, as shown in FIG. 7, via the bucket rotational assembly 48 and allow for viewing and dumping the contents in the bucket 42. As illustrated in FIG. 10, it is possible that the upper roller 72 and the bucket rotational assembly 48 share a rotational axis via an upper attachment bolt 80. The bucket 42 may rotate the full 360 degrees, but it is contemplated that a feature may be added that would restrict the rotational freedom to less than 360 degrees. Additionally, as shown in FIG. 10, the moving handle/roller assembly 46 may include a flange bearing 146 that interfaces with the bucket rotational assembly 48 and provides the bearing surface for upper attachment bolt 80.

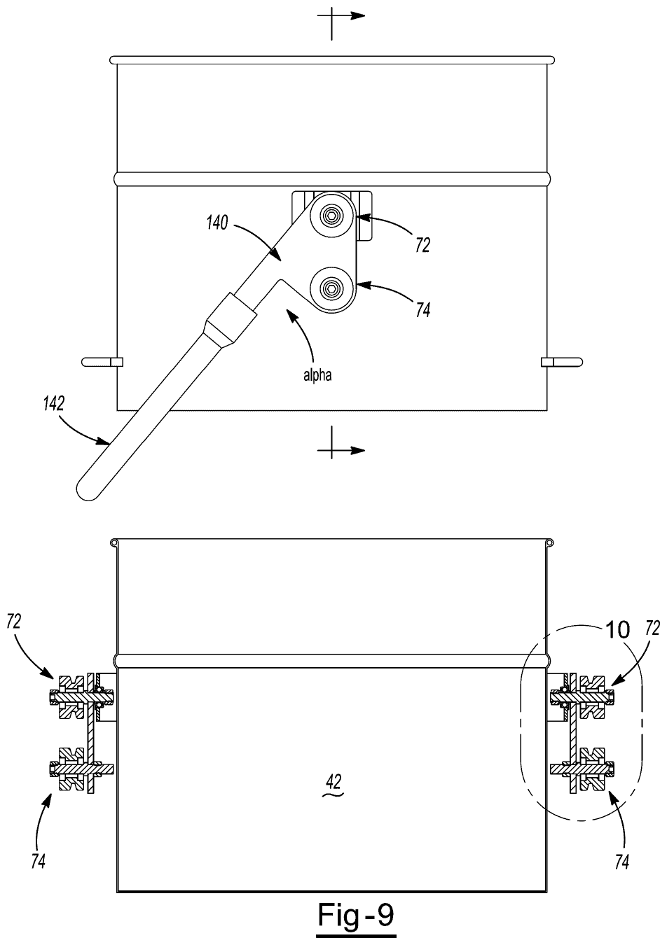

It is contemplated that the moving handle/roller assembly 46 includes a roller bracket portion 140 and a handle portion 142 attached thereto. In one exemplary embodiment, as shown in FIG. 9, the handle portion 142 is disposed at an angle (ALPHA) to the axis of the two rollers 72/74 (same as Section “A”). In a preferred embodiment, ALPHA is about 25 to 65 degrees, more preferably is about 35 to 55 degrees, and most preferably is about 40 to 50 degrees. It is contemplated that the handle portion 142 will rotate approximately 90 degrees (+/−about 5 degrees) from the handle closed position 100′ to the handle open position 200′.

Various embodiments are disclosed herein. It is within the scope of this disclosure that the elements of the embodiments may be combined, duplicated, or separated into additional embodiments. Also, any element disclosed herein may be eliminated from any of the assemblies disclosed herein, duplicated, and/or combined with other elements.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

1: A vacuum/separator for a commercial car wash facility comprising:
a vacuum assembly including at least one vacuum source; and
a movable collector assembly comprising:
a bucket;
one or more mounting/bearing brackets attached to the vacuum assembly and including a vertical channel and a horizontal channel;
a handle/roller assembly movably attached to the one or more mounting/bearing brackets and including a vertical roller and a horizontal roller.

2: The vacuum/separator of claim 1, wherein the vertical roller and the horizontal roller are each disposed in and move within the vertical channel and the horizontal channel respectfully to and from a closed position and an open position.

3: The vacuum/separator of claim 1, wherein the bucket includes a bucket rotational assembly.

4: The vacuum/separator of claim 3, wherein the bucket rotational assembly includes a flange bearing.

5: The vacuum/separator of claim 3, wherein the bucket rotational assembly and the horizontal roller rotate about a pin.

6: The vacuum/separator of claim 1, wherein the horizontal and vertical rollers are located at a first axis in the closed position and a second, different axis in the open position.

7: The vacuum/separator of claim 1, wherein the vacuum assembly includes an upper compartment and a lower compartment.

8: The vacuum/separator of claim 7, wherein dust and small particulate dirt and debris are collected into the upper compartment.

9: The vacuum/separator of claim 7, wherein large and/or heavy debris moves through the lower compartment and into the bucket.

10: The vacuum/separator of claim 7, wherein the vacuum source originates from a suction device in the upper compartment.

11: The vacuum/separator of claim 7, wherein a hose fitting is located on the lower compartment.

12: A vacuum/separator for a commercial car wash facility comprising:
a vacuum assembly including at least one vacuum source; and
a movable collector assembly comprising:
a bucket;
one or more mounting/bearing brackets attached to the vacuum assembly and including a vertical channel and a horizontal channel; and
a handle/roller assembly movably attached to the one or more mounting/bearing brackets and including a vertical roller and a horizontal roller;
wherein the vertical roller and the horizontal roller are each disposed in and move within the vertical channel and the horizontal channel respectfully to and from a closed position and an open position.

13: The vacuum/separator of claim 12, wherein the horizontal and vertical rollers are located at a first axis in the closed position and a second, different axis in the open position.

14: The vacuum/separator of claim 13, wherein the vacuum assembly includes an upper compartment and a lower compartment.

15: The vacuum/separator of claim 14, wherein dust and small particulate dirt and debris are collected into the upper compartment.

16: The vacuum/separator of claim 14, wherein large and/or heavy debris moves through the lower compartment and into the bucket.

17: The vacuum/separator of claim 14, wherein the vacuum source originates from a suction device in the upper compartment.

18: The vacuum/separator of claim 14, wherein a hose fitting is located on the lower compartment.

19: The vacuum/separator of claim 14, wherein the top compartment includes one or more mounting brackets for connecting the vacuum/separator to a car wash assembly.

20: The vacuum/separator of claim 12, wherein the vertical roller includes a flange bearing for receiving an attachment bolt.
